(19) United States
(12) Patent Application Publication
(10) Pub. No.: US 2011/0247766 A1
(43) Pub. Date: Oct. 13, 2011

(54) CONTROL SYSTEM FOR CORDLESS BLINDS

(75) Inventors: WEN-HSING HU, Changhua County (TW); Sheng Ying Hsu, Changhua County (TW)

(73) Assignee: CHING FENG HOME FASHIONS CO., LTD, CHANGHUA COUNTY (TW)

(21) Appl. No.: 12/757,003

(22) Filed: Apr. 8, 2010

(51) Int. Cl. E06B 9/322

(52) U.S. Cl. 160/188

(57) ABSTRACT

A control system for cordless blinds includes at least one wrapping unit, at least one rod and a transmission cord which is wrapped to the at least one rod. Two cords are wrapped to the at least one rod and extend through the slats and are fixed to the bottom bar connected to the lower end of the slats. Two frames are fixed in the top box and located beneath the at least one rod. The frames each include at least one notch so as to support the at least one rod. One of the two frames includes first and second pulleys and the other frame includes a third pulley. The transmission cord and the two cords are wrapped to the pulleys respectively, such that the transmission cord and the two cords are operated smoothly. The number of the rod and the frames can be added as needed.

### FIELD OF THE INVENTION

The present invention relates to a control system for blinds, and more particularly, to a control system for cordless blinds and which makes the operation of the blinds smoothly.

### BACKGROUND OF THE INVENTION

There are two control systems for control of the blinds, the first is the cord type control system and the second is the cordless control system. The cordless control system provides a bottom bar and the users pull or push the bottom bar to control the expansion of the blinds.

A cordless control system known to applicant includes a top box in which a torsion spring and a transmission unit are received. The transmission unit includes two operation cords and a transmission cord, the two operation cords and the transmission cords respectively wrap to two ends of a rod. By the torsion spring, the rod is rotated and the operation cords and the transmission cords are released or retrieved to control the blinds.

However, the widths of the windows that the blinds are used are different, so that the width of the blinds can be so wide that only two operation cords cannot provide sufficient support, and the operation cords could be broken by the heavy load of the wide blinds.

The present invention intends to provide a cordless blind that includes at least one frame which supports the rod on which the operation cord and the transmission cord are wrapped. The number of the frames can be increased to involve more operation cord and the transmission cords when applied to a wide window.

### SUMMARY OF THE INVENTION

The present invention relates to a control system for cordless blinds which comprise a top box, a bottom bar and multiple slats connected between the top box and the bottom bar. The control system comprises at least one wrapping unit located in the top box, at least one rod horizontally located in the top box, and a transmission cord. A first end of the transmission cord is wrapped to the at least one rod. At least one first cord has a first end thereof wrapped to the rod and a second end of the at least one first cord extends through the slats and is fixed to the bottom bar. At least one second cord has a first end thereof wrapped to the rod and a second end of the at least one second cord extends through the slats and is fixed to the bottom bar. At least one first frame and at least one second frame are connected to the top box and located beneath the rod. Each of the at least one first frame and at least one second frame includes a base and a separation plate on the base. The base is fixed to the top box and the separation plate includes at least one notch. The rod is engaged with the at least one notch of the at least one first frame and the at least one notch of the at least one second frame. The at least one first frame includes a first pulley and a second pulley connected thereto. The at least one second frame includes a third pulley connected thereto. The transmission cord is wrapped around the first pulley and the rod. The two respective second ends of the at least one first cord and the at least one second rod are wrapped around the second pulley and the third pulley.

The primary object of the present invention is to provide a control system for cordless blinds, the top box of the cordless blinds includes frames connected to the top box thereof so as to support the rod to which the transmission cords and two cords are wrapped. The frames include pulleys which guide the transmission cords and two cords to be operated smoothly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the blinds and the control system of the present invention;

FIG. 2 shows the frame and the first and second pulleys in the first and second recesses of the frame;

FIG. 3 shows the frame and the third two pulley in the third recess of the frame;

FIG. 4 shows the control system of the present invention;

FIG. 5 shows that the first and second cords are pull downward and the rod moves toward the wrapping unit;

FIG. 6 shows that three frames are provided to support a longer rod;

FIG. 7 shows that four frames are provided to support a longer rod;

FIG. 8 shows that the cordless blinds are cooperated with two frames, two wrapping units and two rods;

FIG. 9 shows that the top bar is lowered away from the top box to obtain a non-covered space;

FIG. 10 shows the control system of the embodiment disclosed in FIG. 8;

FIG. 11 shows that the blinds are lowered and the two rods move in opposite directions;

FIG. 12 shows that three frames are provided to support the two rods in the embodiment disclosed in FIG. 8, and

FIG. 13 shows that four frames are provided to support the two rods in the embodiment disclosed in FIG. 8.

### DETAILED DESCRIPTION OF THE PREFERRED EMBODIMENT

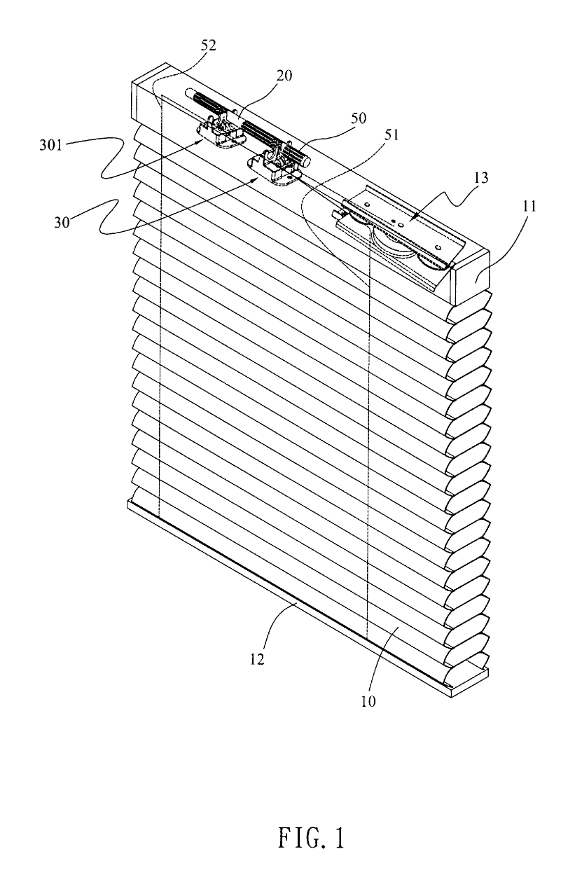

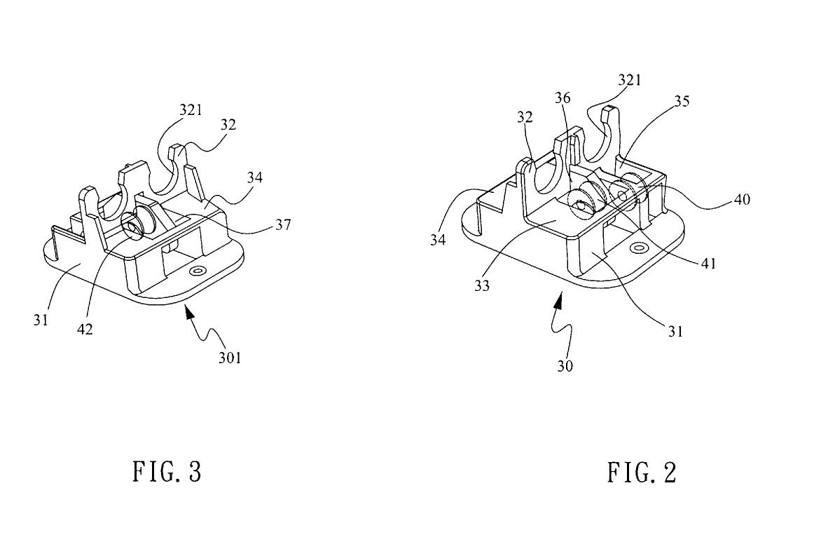

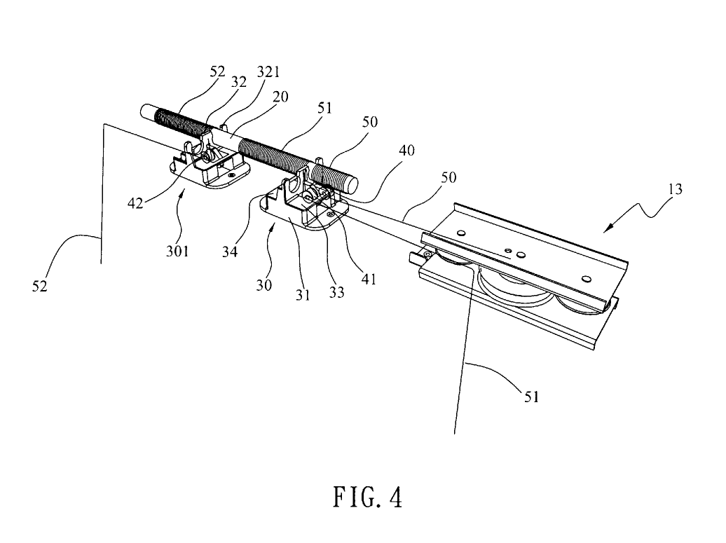

Referring to FIGS. 1 to 4, the present invention relates to cordless blinds which comprise a top box 11, a bottom bar 12 and multiple slats 10 connected between the top box 11 and the bottom bar 12. The control system of the present invention comprises a wrapping unit 13 located in the top box 11 and a rod 20 is horizontally located in the top box 11. The present invention provides first and second frames 30, 301 so as to support the rod 20. The first frame 30 and the second frame 301 are connected to the top box 11 and located beneath the rod 20. Each of the first frame 30 and second frame 301 includes a base 31 which is fixed to the top box 11 and a separation plate 32 is connected to the base 31.

The first frame 30 and the second frame 301 can be identical and each include a first zone 33 and a second zone 34 separated by the separation plate 32. The separation plate 32 of each of the first frame 30 and the second frame 301 includes two notches 321 defined in the top and located close to two ends thereof. The first and second zones 33, 34 are located below the two notches 321. The first zone 33 includes a first recess 35 and a second recess 36, and the second zone 34 includes a third recess 37 located at a central portion thereof. A first pulley 40 is received in the first recess 35, a second pulley 41 is received in the second recess 36, and a third pulley 42 is received in the third recess 37. The two respective axes of the first and second pulleys 40, 41 are parallel to each other and separated by a distance, and an axis of the third pulley 42 is higher than the axes of the first and second pulleys 40, 41.

The first and second frames 30, 301 may not be identical, that is, the first frame 30 has the first and second pulleys 40, 41 connected thereto, but the third recess 37 is omitted. The second frame 301 has the third pulley 42 only and there are no first and second recesses 35, 36.

The rod 20 is engaged with the notches 321 of the first and second frames 30, 301 and a first end of a transmission cord 50 is wrapped to the rod 20. The first frame 30 is located close to the first frame 30. The third pulley 42 in the second frame 301 is located close to the second zone 34 of the first frame 30.

The first end of transmission cord 50 is wrapped around the first pulley 40 of the first frame 30 and then wrapped to an end of the rod 20. A first cord 51 has a first end thereof wrapped to the rod 20 and a second end of the first cord 51 is wrapped around the second pulley 41 and extends through the slats 10 and is fixed to the bottom bar 12. The second cord 52 has a first end thereof wrapped to the rod 20 and a second end of the second cord 52 is wrapped around the third pulley 42 in the second frame 301 and then extends through the slats 10 and is fixed to the bottom bar 12. The first and second cords 51, 52 are located on two sides of the slats 10.

The axes of the first, the second and the third pulleys 40, 41, 42 are located at different positions so that the distance between the rod 20 and the three pulleys 40, 41, 42 are the shortest. This allows the transmission cord 50 and the first and second cords 51, 52 to be operated smoothly and the operation therebetween is not interfered.

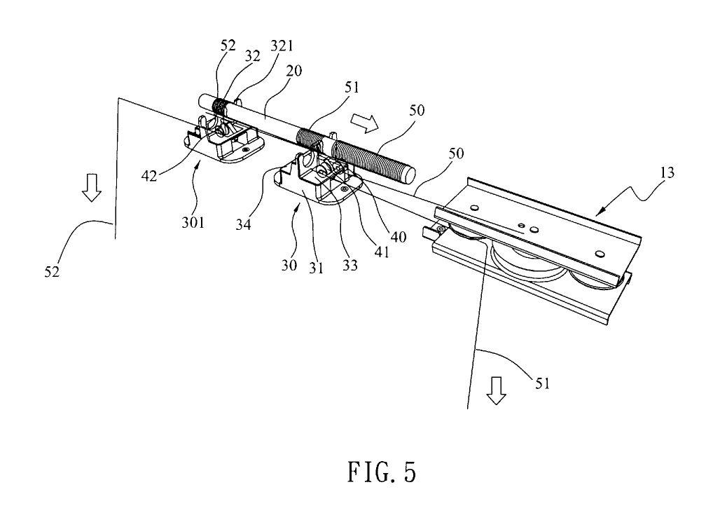

Further referring to FIG. 5, when the bottom bar 12 is pulled downward, the first and second cords 51, 52 are pulled downward and guided by the second and third pulleys 41, 42. The first and second cords 51, 52 are released from the rod 20 and the resilient means in the wrapping unit 13 applies a force to the transmission cord 50 to let the transmission cord 50 be wrapped around the rod 20. The rod 20 is moved toward the wrapping unit 13.

When the bottom bar 12 is pushed upward, the first and second cords 51, 52 are guided by the second and third pulleys 41, 42 and wrapped around the rod 20. The resilient means in the wrapping unit 13 releases the transmission cord 50 from the rod 20 so that the rod 20 is moved back to the original position.

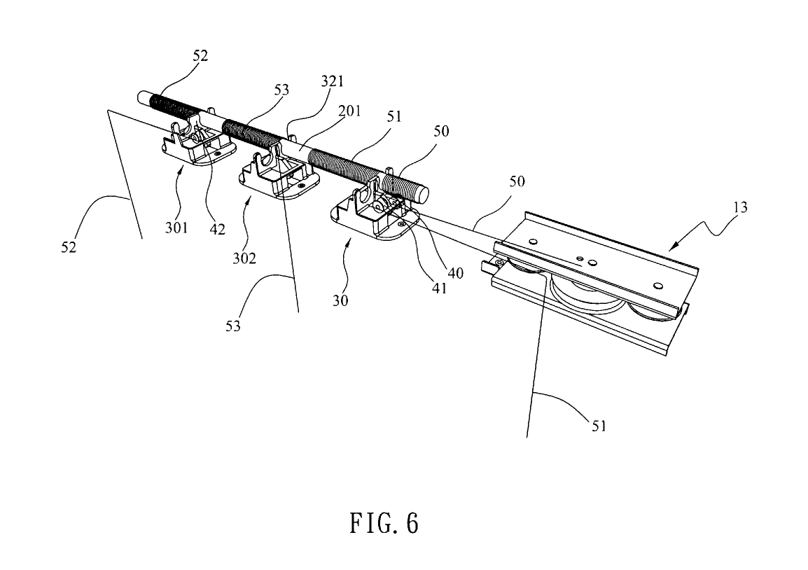

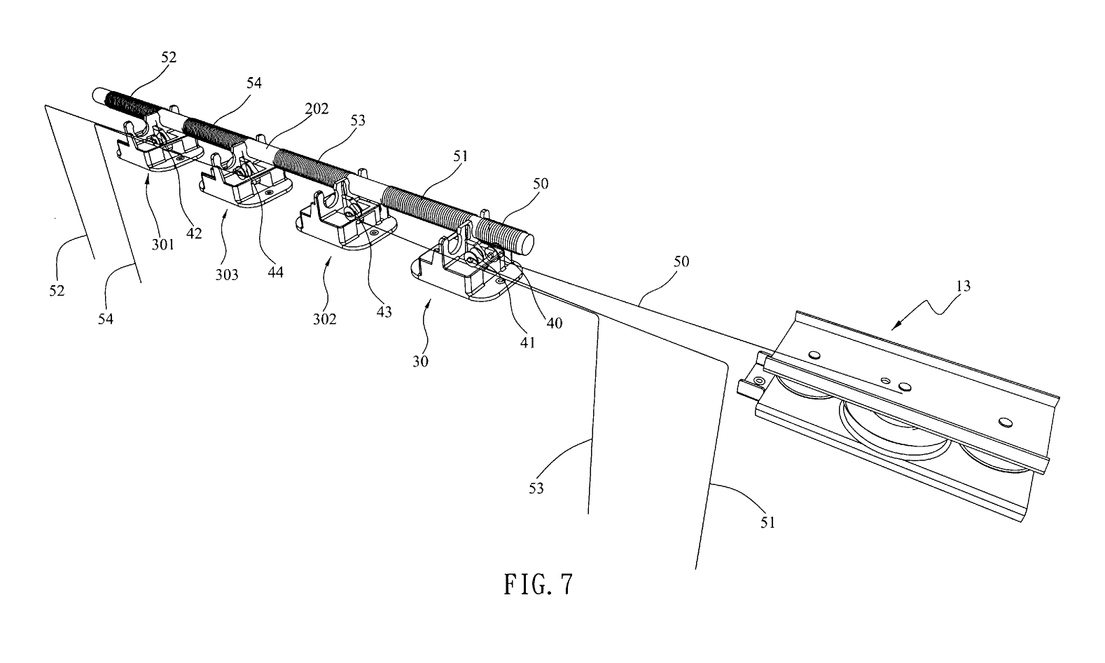

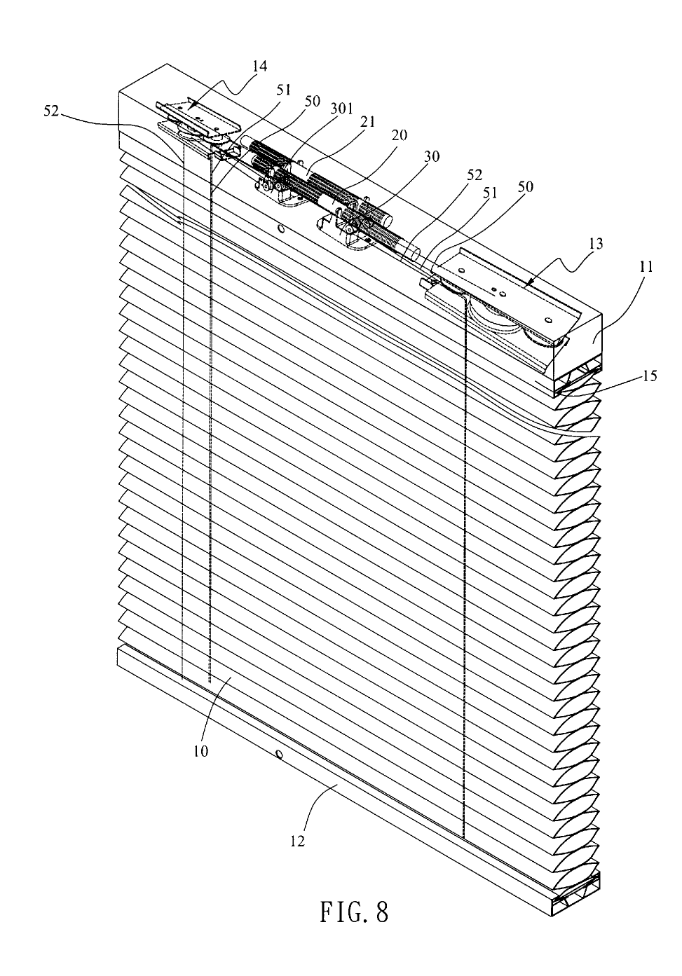

Referring to FIGS. 1, 6 and 7, when the width of the window increases, a third frame 302 is provided which includes notches 321 and the rod 201 is longer than the rod 20 in the previous embodiment. A third cord 53 is wrapped around the rod 201 and extends through the slats 10. The third frame 302 can be no pulley connected thereto. There are four frames 30, 301, 302, 303 provided in FIG. 7 and the rod 202 is supported by the four frames 30, 301, 302, 303. The four frames 30, 301, 302, 303 respectively have five pulleys 40, 41, 42, 43, 44 which are cooperated with the transmission cord 50 and four cords 51, 52, 53, 54.

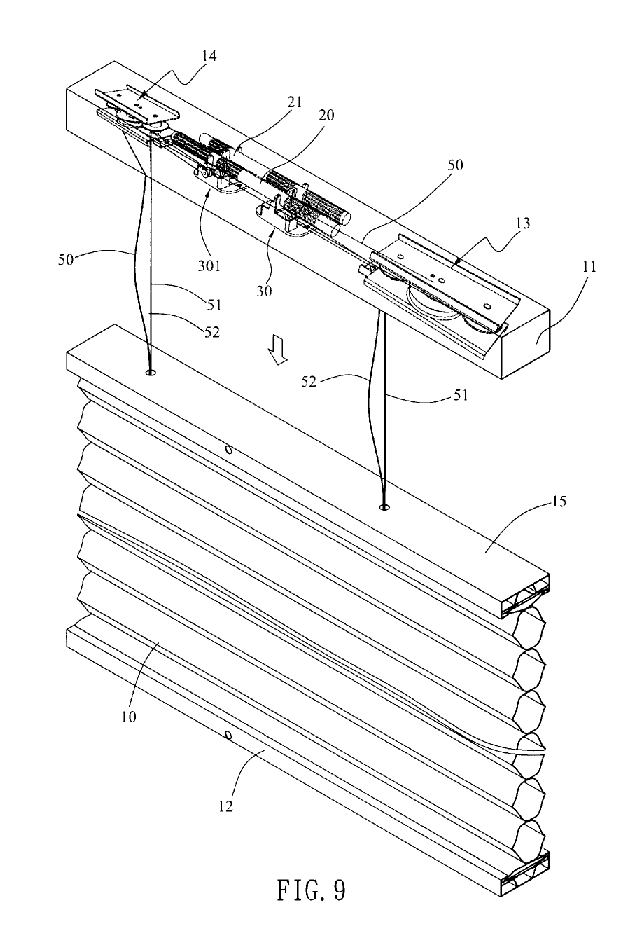

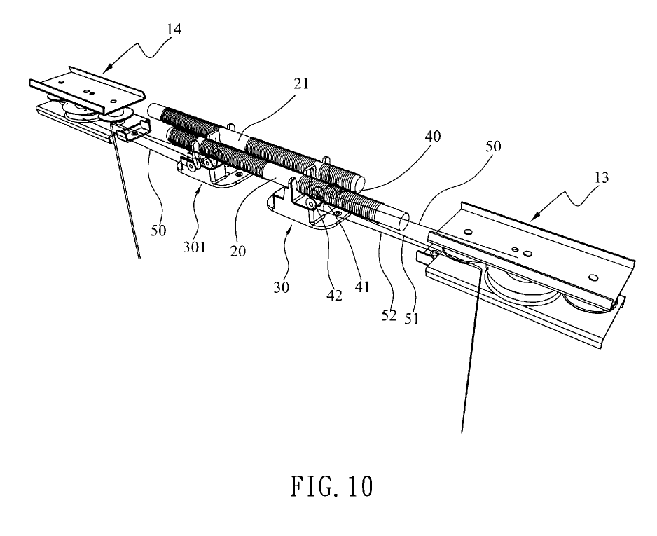

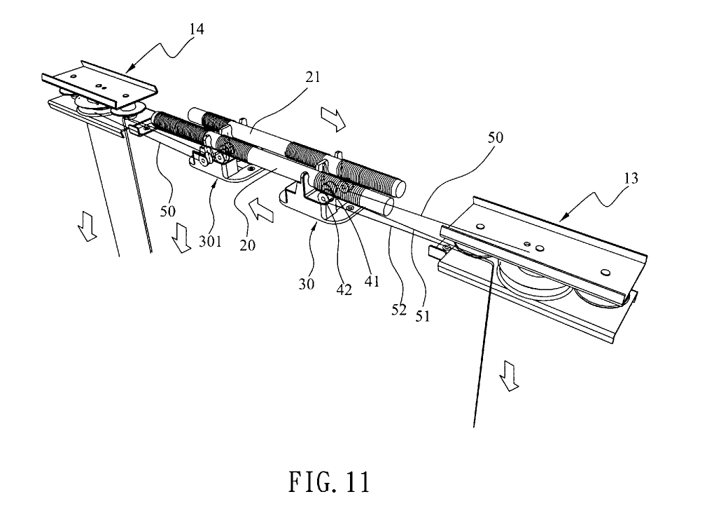

FIGS. 8 to 11 show another embodiment, wherein the two wrapping units 13, 14 support two rods 20, 21 respectively. The wrapping directions of the two rods 20, 21 are in opposite to each other. There are two frames 30, 301 each have the first, the second and the third pulleys 40, 41, 42 so that the transmission cord 50, the first cord 51 and the second cord 52 are guided by the pulleys 40, 41, 42 and extend through the slats 10.

The wrapping unit 14 controls the space between the top box 11 and the slats 10, the wrapping unit 13 controls the slats 10 to move upward and downward. There is a top bar 15 connected to the top of the slats 10 and located between the top box 11 and the top of the slats 10. The transmission cord 50 connected with the second frame 14 controls a distance between the top bar 15 and the top box 11. The users can hold the top bar 15 and pull the top bar 15 downward to move the top bar 15 away from the top box 11 so that there will be a non-covered space formed between the top bar 15 and the top box 11. This is done by the wrapping unit 14 which drives the transmission cord 50, the first cord 51 and the second cord 52.

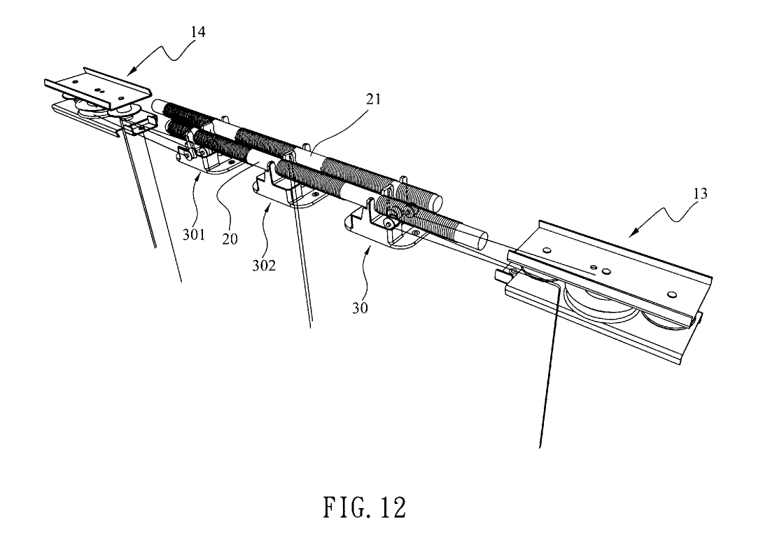

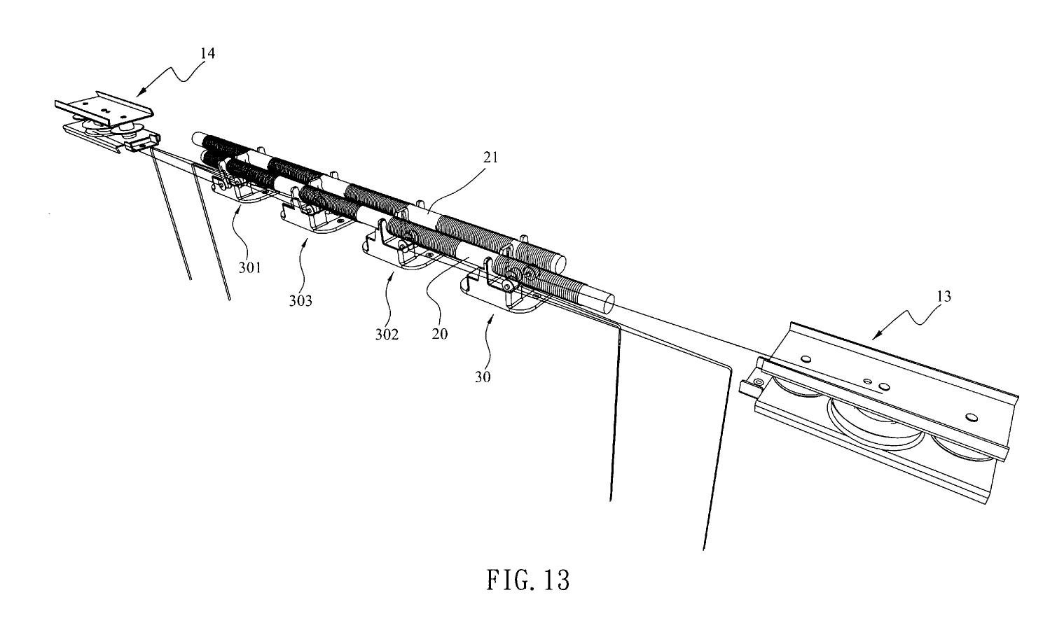

FIGS. 12 and 13 show that the number of the frames can be increased to be three represented by the numerals 30, 301, 302 and four represented by the numerals 30, 301, 302, 303 when needed.

While we have shown and described the embodiment in accordance with the present invention, it should be clear to those skilled in the art that further embodiments may be made without departing from the scope of the present invention.

What is claimed is:

1. A control system for cordless blinds which comprise a top box, a bottom bar and multiple slats connected between the top box and the bottom bar, the control system comprising:
at least one wrapping unit located in the top box and including a transmission cord;
at least one rod horizontally located in the top box and a first end of the transmission cord wrapped to the at least one rod;
at least one first cord having a first end thereof wrapped to the rod and a second end of the at least one first cord adapted to extend through the slats and be fixed to the bottom bar, at least one second cord having a first end thereof wrapped to the rod and a second end of the at least one second cord adapted to extend through the slats and be fixed to the bottom bar, and
at least one first frame and at least one second frame connected to the top box and located beneath the rod, each of the at least one first frame and at least one second frame including a base and a separation plate on the base, the base fixed to the top box and the separation plate including at least one notch, the rod engaged with the at least one notch of the at least one first frame and the at least one notch of the at least one second frame, the at least one first frame including a first pulley and a second pulley connected thereto, the at least one second frame including a third pulley, the transmission cord wrapped around the first pulley and the rod, the two respective second ends of the at least one first cord and the at least one second rod wrapped around the second pulley and the third pulley.

2. The control system as claimed in claim 1, wherein the at least one first frame and the at least one second frame are identical and each include a first zone and a second zone separated by the separation plate, the separation plate of each of the at least one first frame and the at least one second frame includes two notches defined in a top and located close two ends thereof, the first and second zones are located below the two notches, the first zone includes a first recess and a second recess, the second zone includes a third recess located at a central portion thereof, the first pulley is received in the first recess, the second pulley is received in the second recess, a third pulley is received in the third recess, two respective axes of the first and second pulleys are parallel to each other and separated by a distance, an axis of the third pulley is higher than the axes of the first and second pulleys.

3. The device as claimed in claim 1 further comprising a second wrapping unit and a second rod, the at least one rod and the second rod having two opposite wrapping directions to the transmission cords, the first cords and the second cords wrapped thereto, each of the at least one first frame and at least one second frame having the first pullet, the second pulley and a third pulley connected thereto, the transmission cord connected to the second frame extending through the slats, a top bar connected to a top of the slats and located between the top box and the top of the slats, the transmission cord connected with the second frame controlling a distance between the top bar and the top box.
